(19) United States
(12) Patent Application Publication
(10) Pub. No.: US 2010/0076749 A1
(43) Pub. Date: Mar. 25, 2010

(54) LANGUAGE PROCESSING SYSTEM, LANGUAGE PROCESSING METHOD, LANGUAGE PROCESSING PROGRAM, AND RECORDING MEDIUM

(75) Inventors: Seiya Osada, Tokyo (JP); Kiyoshi Yamabana, Tokyo (JP); Jinan Xu, Tokyo (JP); Takahiro Ikeda, Tokyo (JP); Kunihiko Sadamasa, Tokyo (JP)

Correspondence Address: Mr. Jackson Chen, 6535 N. STATE HWY 161, IRVING, TX, 75039, US

(73) Assignee: NEC CORPORATION, Tokyo (JP)

(21) Appl. No.: 12/529,376

(22) PCT Filed: Feb. 22, 2008
(86) PCT No.: PCT/JP2008/000302

§ 371 Date: Nov. 13, 2009

(30) Foreign Application Priority Data
Mar. 1, 2007 (JP) 2007-051089

(51) Int. Cl. G06F 17/27; G06F 17/21

(52) U.S. Cl. 704/9; 704/10

(57) ABSTRACT

A language processing system according to the present invention includes: an input device 1 that receives an input of an input document; and a unit selecting dictionary 22 that selects a document-information-attached user dictionary that is a user dictionary to which document information is attached. The unit selecting dictionary 22 selects the dictionary, based on the degree of similarity between the input document input from the input unit 1 and the document information attached to the document-information-attached user dictionary. The language processing system further includes a document-information-attached user dictionary storage unit 31 that stores the document-information-attached user dictionary. One or more sentences are attached as the document information to the document-information-attached user dictionary.

The present invention relates to a language processing system that has a user dictionary function, a language processing method, a language processing program, and a recording medium.

### BACKGROUND ART

A conventional language processing system having a user dictionary function is disclosed in Patent Document 1. In the system disclosed in this document, user dictionaries in each field are created by users. The frequency of appearance of each word in input documents is detected in each field, and the user dictionary corresponding to the field with the highest frequency is selected by the system.

In Patent Document 2, a technique is disclosed by which not only restrictions but also example sentences are written in dictionaries, so as to select appropriate word meanings. Accordingly, a similarity search function that is equivalent to a translation technique based on case examples is used, in case a word meaning cannot be selected based only on restrictions.

[Patent Document 1] Japanese Patent Application Laid-Open No. 2001-5812

[Patent Document 2] Japanese Patent Application Laid-Open No. 5-204965

### DISCLOSURE OF THE INVENTION

In a conventional language processing system, however, a field edifice is set in advance, and the field under which the subject user dictionary is classified needs to be selected from the fields included in the edifice. Therefore, if the field to which the subject input document belongs is not included in the field edifice, it is difficult to select an appropriate word meaning by referring to a user dictionary.

According to the present invention, there is provided a language processing system comprising: an input unit that receives an input of an input document; and a unit selecting dictionary that selects a document-information-attached user dictionary that is a user dictionary to which document information is attached. The unit selecting dictionary selects the document-information-attached user dictionary, based on the degree of similarity between the input document input from the input unit and the document information attached to the document-information-attached user dictionary.

According to the present invention, there is provided a language processing method comprising: receiving an input of an input document, the input being received by an input unit; and selecting a document-information-attached user dictionary that is a user dictionary to which document information is attached. In selecting the document-information-attached user dictionary, the selection is performed based on the degree of similarity between the input document input from the input unit and the document information attached to the document-information-attached user dictionary.

According to the present invention, there is provided a language processing program that causes a computer to: receive an input of an input document, the input being received by an input unit; and select a document-information-attached user dictionary that is a user dictionary to which document information is attached. In selecting the document-information-attached user dictionary, the selection is performed based on the degree of similarity between the input document input from the input unit and the document information attached to the document-information-attached user dictionary.

According to the present invention, there is provided a recording medium that stores a language processing program that causes a computer to: receive an input of an input document, the input being received by an input unit; and select a document-information-attached user dictionary that is a user dictionary to which document information is attached. In selecting the document-information-attached user dictionary, the selection is performed based on the degree of similarity between the input document input from the input unit and the document information attached to the document-information-attached user dictionary.

The present invention can provide a language processing system that can select a word meaning without dependence on a field edifice, a language processing method, a language processing program, and a recording medium storing the program.

### BRIEF DESCRIPTION OF THE DRAWINGS

The above mentioned objects and other objects, and features and advantages of the present invention will become more apparent from the following preferred embodiments described later when read in conjunction with the accompanying drawings.

FIG. 1 is a block diagram showing a first embodiment of a language processing system in accordance with the present invention;

FIG. 2 is a diagram showing example contents of a document-information-attached user dictionary;

FIG. 3 is a flowchart for explaining an example of the operation of the language processing system shown in FIG. 1;

FIG. 4 is a block diagram showing a second embodiment of a language processing system in accordance with the present invention;

FIG. 5 is a block diagram showing a third embodiment of a language processing system in accordance with the present invention;

FIG. 6 is a block diagram showing a fourth embodiment of a language processing system in accordance with the present invention;

FIG. 7 is a block diagram showing a fifth embodiment of a language processing system in accordance with the present invention;

FIG. 8 is a block diagram showing a sixth embodiment of a language processing system in accordance with the present invention;

FIG. 9 is a flowchart for explaining an example of the operation of the language processing system shown in FIG. 8;

FIG. 10 is a diagram for explaining an example of the operation of the language processing system shown in FIG. 8;

FIG. 11 is a block diagram showing a seventh embodiment of a language processing system in accordance with the present invention;

FIG. 12 is a diagram for explaining Example 1 of the present invention;

FIG. 13 is a diagram for explaining Example 6 of the present invention;

FIG. 14 is a diagram for explaining Example 6 of the present invention;

FIG. 15 is a flowchart for explaining Example 6 of the present invention;

FIG. 16 is a diagram for explaining a modification of the example; and

FIG. 17 is a block diagram showing an eighth embodiment of a language processing system in accordance with the present invention.

### BEST MODE FOR CARRYING OUT THE INVENTION

The following is a detailed description of preferred embodiments of the present invention, with reference to the accompanying drawings. Like components are denoted by like reference numerals in the drawings, and explanation of those components is not repeated.

### First Embodiment

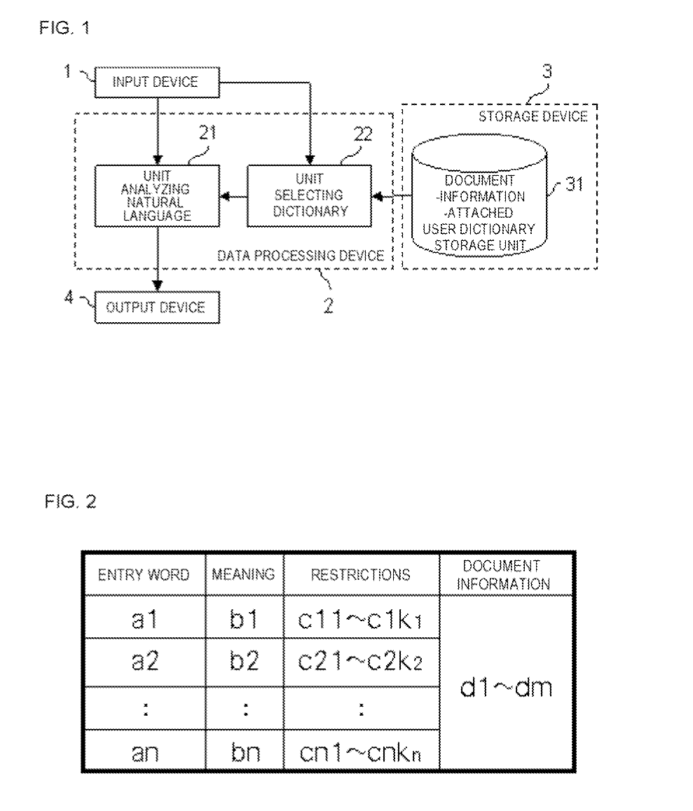

FIG. 1 is a block diagram of a first embodiment of a language processing system in accordance with the present invention. This language processing system includes an input device 1 (the input unit) that receives inputs of input documents, and a unit selecting dictionary 22 that selects a document-information-attached user dictionary that is a user dictionary having document information attached thereto. The unit selecting dictionary 22 selects a user dictionary, based on the similarity between the input document input from the input device 1 and the document information attached to the document-information-attached user dictionary.

In this embodiment, each user dictionary is accompanied by document information, and a user dictionary is selected based on the similarity between the document-information-attached user dictionary and an input document. Accordingly, a word meaning can be selected without dependence on a field edifice.

More specifically, the language processing system of this embodiment includes the input device 1 such as a keyboard, a data processing device 2 that operates under program control, a storage device 3 that stores information, and an output device 4 such as a display device.

The storage device 3 has a document-information-attached user dictionary storage unit 31 that stores document-information-attached user dictionaries. FIG. 2 shows an example of a document-information-attached user dictionary. The contents of the document-information-attached user dictionary include entry word information to be used for performing language processing, word meanings, restriction information (restrictions) on selecting each word meaning, and document information related to the dictionary. Such document-information-attached user dictionaries are stored in the document-information-attached user dictionary storage unit 31.

The data processing device 2 includes a unit analyzing natural language 21 and a unit selecting dictionary 22. The unit selecting dictionary 22 calculates the degree of similarity between a document input from the input device 1 and each sentence stored as the document information in the document-information-attached user dictionary storage unit 31, and selects a user dictionary indicating the highest degree of similarity. More specifically, the document-information-attached user dictionary having the highest degree of similarity with the input document is selected from the document-information-attached user dictionaries stored in the document-information-attached user dictionary storage unit 31.

The degree of similarity is determined by the number of words shared and included between the input document and the document information attached to the document-information-attached user dictionary. Accordingly, a user dictionary having document information containing a larger number of shared and included words indicates a higher degree of similarity.

The unit analyzing natural language 21 performs a natural language analysis on an input document with the use of the dictionary selected by the unit selecting dictionary 22.

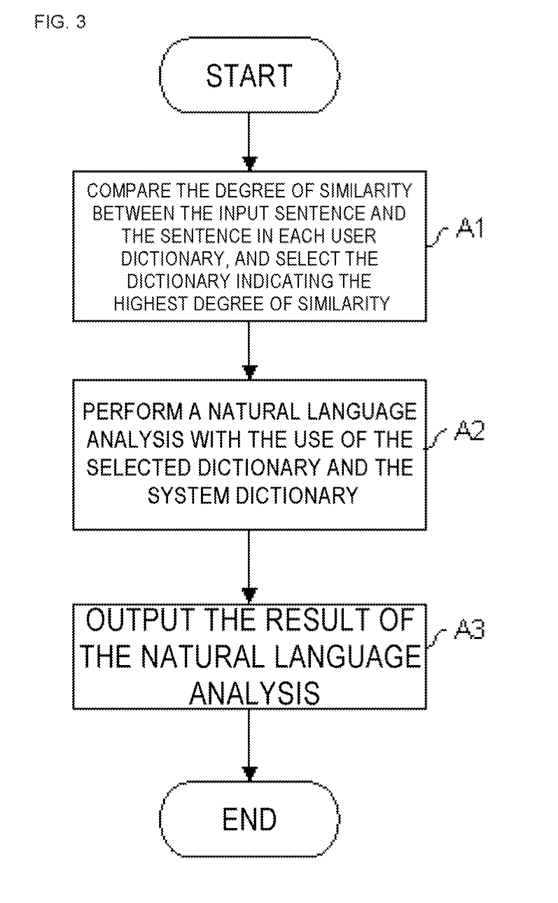

Referring now to the flowchart shown in FIG. 3, an example of the operation of the language processing system shown in FIG. 1 is described as an embodiment of a language processing method and a language processing program in accordance with the present invention. This method includes an input step in which the input device 1 receives an input of an input document, and a dictionary select step in which a document-information-attached user dictionary is selected. In the dictionary select step, a user dictionary is selected based on the degree of similarity between the input document input from the input device 1 and the document information attached to each document-information-attached user dictionary. The language processing program of this embodiment causes a computer to carry out these steps.

More specifically, the unit selecting dictionary 22 first calculates the degree of similarity between a document input from the input device 1 and each document stored in the document-information-attached user dictionary storage unit 31. The unit selecting dictionary 22 then selects the dictionary indicating the highest degree of similarity (step A1).

The unit analyzing natural language 21 performs a natural language analysis with the use of the selected document-information-attached user dictionary and a system dictionary (step A2). The result of the natural language analysis is output from the output device 4 (step A3).

The effects of this embodiment are now described. In this embodiment, the input device 1 receives an input of an input document. Document information is attached to each user dictionary. Based on the degree of similarity between each document-information-attached user dictionary and the input document, the unit selecting dictionary 22 selects a user dictionary. Accordingly, a word meaning can be selected without dependence on the field edifice. Furthermore, a word meaning can be selected with the use of document information even in a language processing system that docs not have a word meaning selecting function using example sentences.

Also, a word meaning is selected with the use of document information, without using a field edifice. Accordingly, when a user creates a user dictionary, the user does not need to designate a field in accordance with the field edifice depending on the system.

On the other hand, the conventional language processing system has the following four problems. The first problem is that the conventional language processing system cannot cope with a field, that is set by a certain language processing system and is not contained in the field edifice, and cannot cope with a case in which further segmentation is needed for the fields set in the system. This is because users cannot freely set fields, since fields are set in each language processing system.

The second problem is that it is not possible to create a user dictionary for each field that can be used not only in a certain language processing system but also in various language processing systems. This is because a field edifice is set in each language processing system, and there is not a common field edifice shared among all the language processing systems.

The third problem is that it is hard for users to classify user dictionaries into correct categories. This is because, even if there is a collective field edifice that can be used in all the language processing systems, each user needs to understand the collective field edifice, and classify user dictionaries into correct categories.

The fourth problem is that, even if example sentences are added to each user dictionary, the example sentences cannot be used in various language processing systems. This is because there are few language processing systems having the function disclosed in Patent Document 2. Even if a user dictionary including example sentences is created for the use in this language processing system, it is not possible to select a word meaning with the use of information about the example sentences in any other language processing system.

In accordance with this embodiment, those problems can be solved.

### Second Embodiment

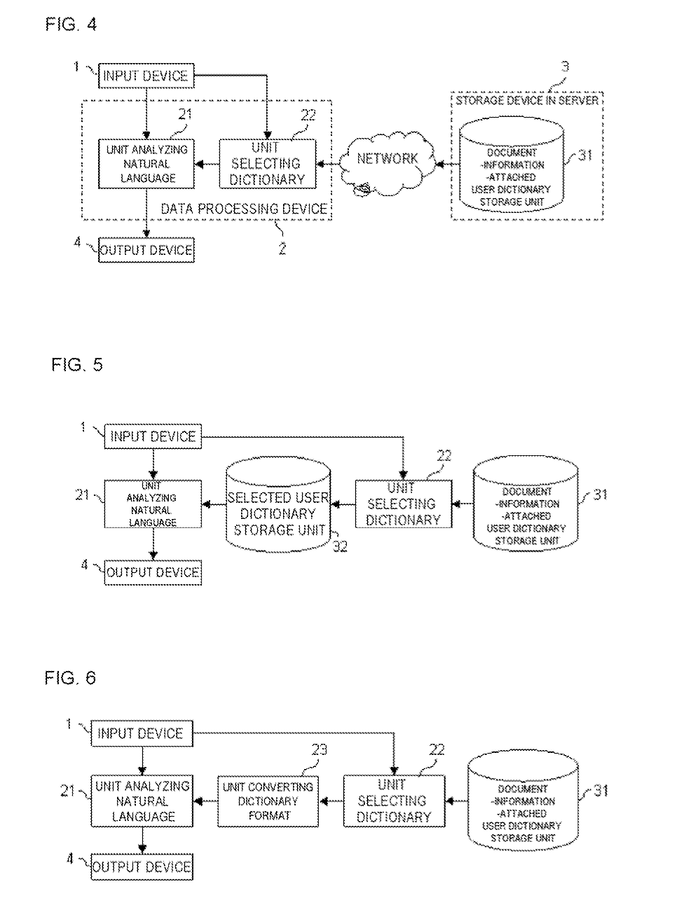

FIG. 4 is a block diagram of a second embodiment of a language processing system in accordance with the present invention. In this embodiment, the document-information-attached user dictionary storage unit 31 is stored in a server located outside the network. The other structures of this embodiment are the same as those of the first embodiment. The unit selecting dictionary 22 refers to the document-information-attached user dictionaries stored in the storage device 3 in server via the network, to select the dictionary indicating the highest degree of similarity.

In accordance with this embodiment, the document-information-attached user dictionary storage unit 31 is stored in the server. Accordingly, it is easy to use a user dictionary created by another user in the server.

### Third Embodiment

FIG. 5 is a block diagram of a third embodiment of a language processing system in accordance with the present invention. This embodiment further includes a selected user dictionary storage unit 32. The other structures of this embodiment are the same as those of the first or second embodiment. The selected user dictionary storage unit 32 stores document-information-attached user dictionaries that have already been selected by the unit selecting dictionary 22. The unit analyzing natural language 21 refers to the selected user dictionary storage unit 32, to perform a natural language analysis.

In accordance with this embodiment, the dictionaries already selected by the unit selecting dictionary 22 are stored in the selected user dictionary storage unit 32. Accordingly, when the next document is input from the input device 1, the unit selecting dictionary 22 does not need to calculate the degree of similarity, and a natural language analysis can be performed by the unit analyzing natural language 21 with the use of the selected user dictionary storage unit 32. Accordingly, when a dictionary that has been used for a previous document and is stored in the selected user dictionary storage unit 32 is desired to be used, the unit selecting dictionary 22 does not need to calculate the degree of similarity, and a high-speed natural language analysis can be performed.

### Fourth Embodiment

FIG. 6 is a block diagram showing a fourth embodiment of a language processing system in accordance with the present invention. This embodiment further includes a unit converting dictionary format 23. The other aspects in the structure of this embodiment are the same as those of the first embodiment. The unit converting dictionary format 23 converts the format of a document-information-attached user dictionary selected by the unit selecting dictionary 22 into a format that can be used by another unit analyzing natural language.

In this embodiment, the unit converting dictionary format 23 may be added not only to the first embodiment illustrated in FIG. 1, but also to the second embodiment illustrated in FIG. 4 or the third embodiment illustrated in FIG. 5.

In accordance with this embodiment, the format of a dictionary selected by the unit selecting dictionary 22 is converted into a format that can be used by another unit analyzing natural language. Accordingly, the unit analyzing natural language 21 can be turned into another unit analyzing natural language having the same function. Thus, even if the unit analyzing natural language is changed to that of another system, each user dictionary can be used as it is.

### Fifth Embodiment

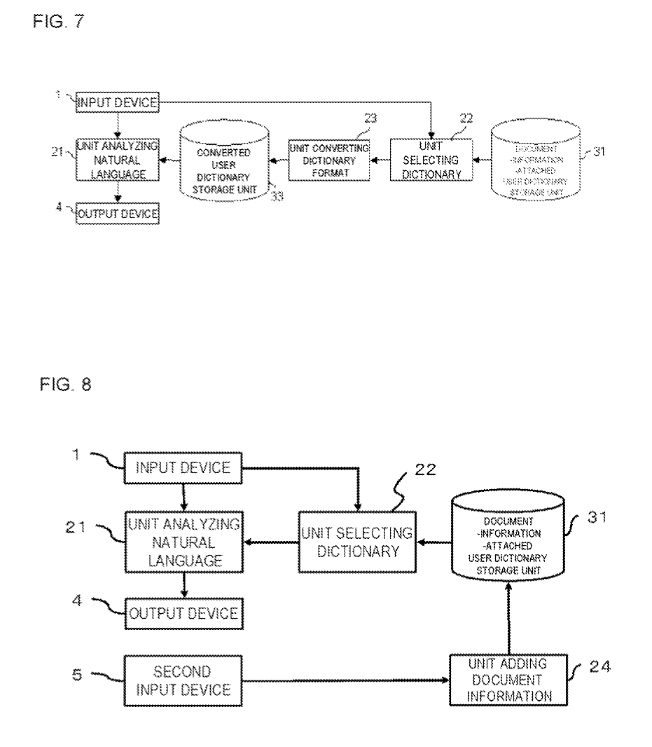

FIG. 7 is a block diagram showing a fifth embodiment of a language processing system in accordance with the present invention. This embodiment further includes a converted user dictionary storage unit 33. The other aspects in the structure of this embodiment are the same as those of the fourth embodiment illustrated in FIG. 6. The converted user dictionary storage unit 33 stores dictionaries having their dictionary formats converted by the unit converting dictionary format 23. The unit analyzing natural language 21 refers to the converted user dictionary storage unit 33, to perform a natural language analysis.

In accordance with this embodiment, the dictionaries having their formats converted by the unit converting dictionary format 23 are stored in the converted user dictionary storage unit 33. Accordingly, when the next document is input from the input device 1, the unit selecting dictionary 22 is not required to calculate the degree of similarity, and the unit converting dictionary format 23 is not required to convert the dictionary format. Instead, a natural language analysis can be performed by the unit analyzing natural language 21 with the use of the converted user dictionary storage unit 33. When a dictionary that has been used for a previous document and is stored in the converted user dictionary storage unit 33 is desired to be used, the unit selecting dictionary 22 is not required to select a degree of similarity, and the unit converting dictionary format 23 is not required to convert the dictionary format. Thus, a high-speed natural language analysis can be performed.

### Sixth Embodiment

FIG. 8 is a block diagram of a sixth embodiment of a language processing system in accordance with the present invention. This embodiment further includes a second input device 5 and a unit adding document information 24. The other aspects in the structure of this embodiment are the same as those of the fifth embodiment.

In this embodiment, the second input device 5 and the unit adding document information 24 may be added not only to the fifth embodiment illustrated in FIG. 7, but also to the first embodiment illustrated in FIG. 1, the second embodiment illustrated in FIG. 4, the third embodiment illustrated in FIG. 5, or the fourth embodiment illustrated in FIG. 6.

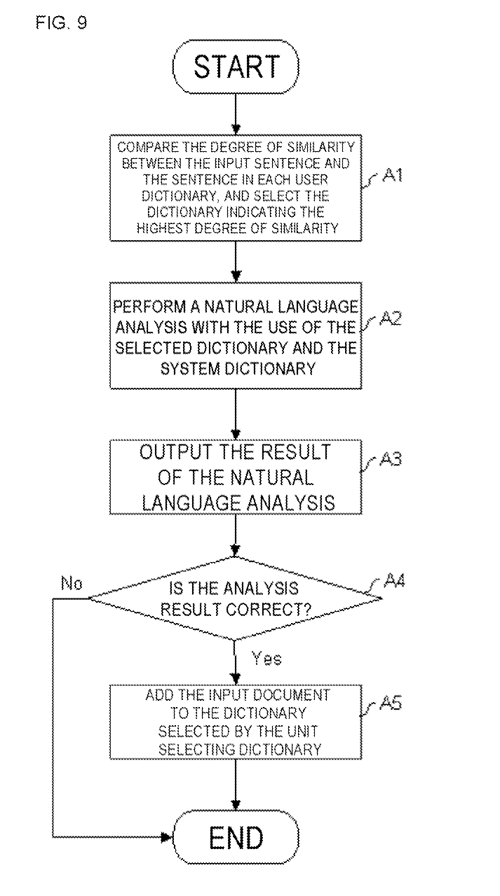

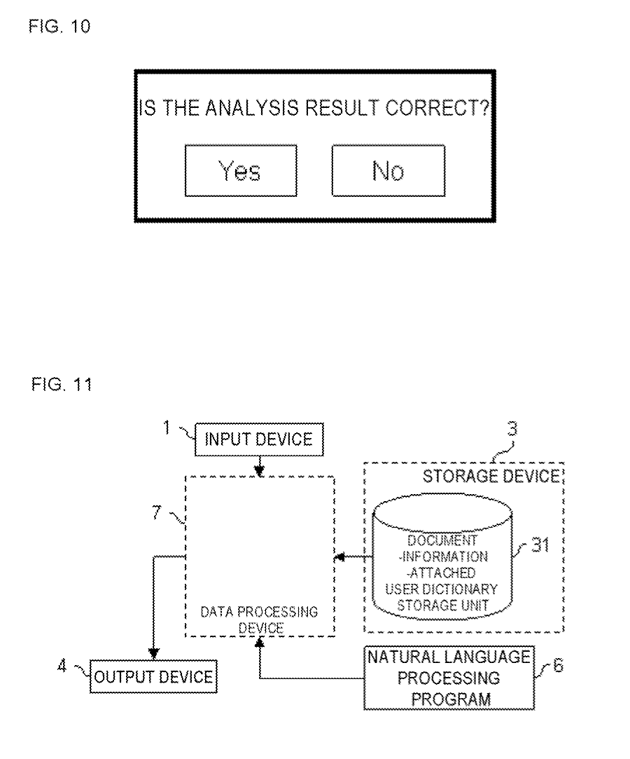

Referring now to FIGS. 9 and 10, an example of the operation of the language processing system illustrated in FIG. 8 is described. The procedures of steps A1 through A3 are the same as those of the first embodiment shown in FIG. 3.

In this embodiment, after the result of the natural language analysis is output in step A3, the user determines whether the analysis result is correct. If the analysis result is correct, the user presses the “Yes” button of the second input device 5 as shown in FIG. 10, and if the analysis result is not correct, the user presses the “No” button (step A4).

When the result from the second input device 5 is “Yes”, the unit adding document information 24 adds the information about the document input from the input device 1 to the dictionary selected by the unit selecting dictionary 22 (step A5).

In accordance with this embodiment, the language processing system includes the second input device 5 and the unit adding document information 24. Accordingly, document information can readily be added to the document-information-attached user dictionary storage unit 31. Thus, a large amount of document information can be easily gathered in the document-information-attached user dictionary storage unit 31.

### Seventh Embodiment

FIG. 11 is a block diagram showing a seventh embodiment of a language processing system in accordance with the present invention. Like the first, second, third, fourth, fifth, and sixth embodiment, this embodiment includes an input device, a data processing device, a storage device, and an output device.

A natural language processing program is read by a data processing device 7, and controls the operation of the data processing device 7, which carries out the same processing as those carried out by the data processing device in each of the first, second, third, fourth, fifth, and sixth embodiments. The natural language processing program is stored in a recording medium 6, and is read from the recording medium 6 into the data processing device 7. Here, the recording medium 6 may be a removable disk, a hard disk, or a semiconductor memory, for example, and some other type of recording medium. Alternatively, the natural language processing program may be read from a server into the data processing device 7 via an Internet line or a communication line such as a Local Area Network (LAN).

### Eighth Embodiment

FIG. 17 is a block diagram showing an eighth embodiment of a language processing system in accordance with the present invention. In this embodiment, the input device 1 has the functions of the second input device 5 of the sixth embodiment. The other structure and the operation of the language processing system of this embodiment are the same as those of the sixth embodiment. In this embodiment, the same procedures as those in the sixth embodiment can also be carried out.

The input device 1 may have the functions of the second input device 5 of the sixth embodiment not only in the fifth embodiment illustrated in FIG. 7, but also in the first embodiment illustrated in FIG. 1, the second embodiment illustrated in FIG. 4, the third embodiment illustrated in FIG. 5, and the fourth embodiment illustrated in FIG. 6. Further, the unit adding document information 24 may be added not only to the fifth embodiment illustrated in FIG. 7, but also to the first embodiment illustrated in FIG. 1, the second embodiment illustrated in FIG. 4, the third embodiment illustrated in FIG. 5, or the forth embodiment illustrated in FIG. 6.

### Example 1

Referring to the accompanying drawings, Example 1 of the present invention is described. This example corresponds to the first embodiment.

A language processing system of this example includes a keyboard as the input device, a personal computer as the data processing device, a magnetic disk device as the data storage device, and a display as the output device.

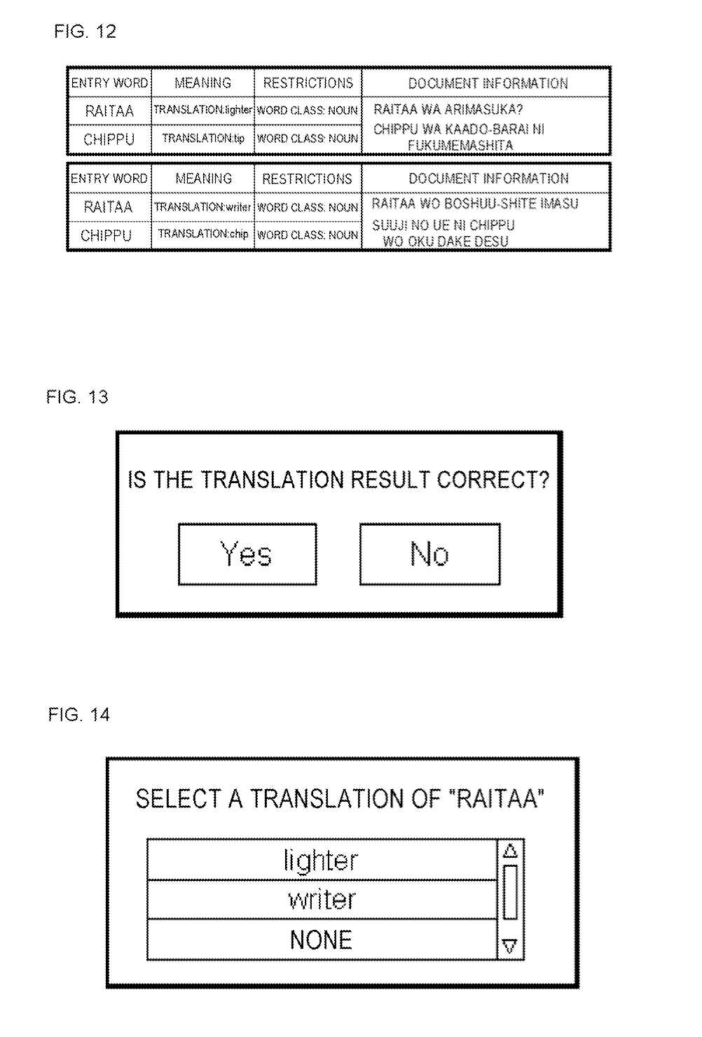

The personal computer has a central processing unit that functions as the unit analyzing natural language and the unit selecting dictionary. A document-information-attached user dictionary is stored in the magnetic disk device. FIG. 12 shows an example of the format of the document-information-attached dictionary.

The two dictionaries as shown in FIG. 12 are stored in the document-information-attached user dictionary, for example. In the first dictionary, a translation word “lighter” is stored as the meaning of an entry word “raitaa”, and the word class of noun is stored as the restriction.

A translation word “tip” is stored as the meaning of an entry word “chippu”, and the word class of noun is stored as the restriction. Further, the two sentences, “Raitaa wa arimasuka” and “Chippu wa kaado-barai ni fukumemashita”, are registered in this dictionary.

In the second dictionary, a translation word “writer” is stored as the meaning of an entry word “raitaa”, and the word class of noun is stored as the restriction. A translation word “chip” is stored as the meaning of an entry word “chippu”, and the word class of noun is stored as the restriction. Further, the two sentences, “Raitaa wo boshuu-shite imasu” and “Suuji no ue ni chippu wo oku dake desu”, are registered in this dictionary.

A document containing the two sentences, “Raitaa wa kaado de kaemasuka” and “Chippu komi desuka”, is now input as an input document through the keyboard.

The central processing unit counts the number of words shared between the input document and the sentences in the first dictionary, and the number of words shared between the input document and the sentences in the second dictionary. The central processing unit then determines which dictionary has the larger number of shared words, and selects the dictionary having the larger number of shared words.

In the case shown in FIG. 12, for example, the first dictionary has three shared words, “raitaa”, “chippu”, and “kaado”, while the second dictionary has two shared words, “raitaa” and “chippu”. Accordingly, the first dictionary is selected.

The central processing unit serving as the unit analyzing natural language next performs a machine translation operation with the use of the selected dictionary as the user dictionary. In the machine translation operation, “Raitaa wa kaado de kaemasuka” is translated as “Can I buy a lighter by my credit card?”, and “Chippu komi desuka” is translated as “Does it include a tip?”. The translations are then output to the display.

### Example 2

Next, Example 2 of the present invention is described. This example corresponds to the second embodiment. This example has the same structure as the structure of Example 1, except that document-information-attached user dictionaries are stored in a data storage device of a server in a network.

The central processing unit refers to an input document and the document-information-attached user dictionaries stored in the data storage device of the server in the network, so as to select a dictionary.

### Example 3

Next, Example 3 of the present invention is described. This example corresponds to the third embodiment: This example has the same structure as the structure of Example 1, except that each user dictionary selected by the central processing unit serving as the unit selecting dictionary is stored as a selected user dictionary into the data storage unit.

Each dictionary selected by the central processing unit serving as the unit selecting dictionary is stored as a selected user dictionary into the data storage unit. The central processing unit then performs a machine translation operation as the natural language analyzing operation with the use of the selected user dictionary as the user dictionary.

### Example 4

Next, Example 4 of the present invention is described. This example corresponds to the fourth embodiment. This example has the same structure as the structure of Example 1, except that the central processing unit includes a unit converting dictionary format that converts each user dictionary selected by the central processing unit serving as the unit selecting dictionary into a user dictionary format that can be used by a certain unit analyzing natural language.

### Example 5

Next, Example 5 of the present invention is described. This example corresponds to the fifth embodiment. This example has the same structure as the structure of Example 4, except that each user dictionary converted by the central processing unit serving as the unit converting dictionary format is stored as a converted user dictionary into the data storage unit.

Each dictionary converted by the central processing unit serving as the unit converting dictionary format is stored as a converted user dictionary into the data storage unit. The central processing unit then performs a machine translation operation as the natural language analyzing operation with the use of the converted user dictionary as the user dictionary.

### Example 6

Referring now to an accompanying drawing, Example 6 of the present invention is described. This example corresponds to the sixth embodiment. FIG. 15 shows the procedures of an operation in this example.

This example has the same structure as the structure of Example 1, except that a mouse is provided as the second input device, and the central processing unit includes the unit adding document information.

A user handles the mouse on the screen shown in FIG. 13, so as to indicate whether the sentences “Can I buy a lighter by my credit card?” and “Does it include a tip?” output on the display are correct as the translations of “Raitaa wa kaado de kaemasuka” and “Chippu komi desuka” of an input document (step A4). If the input by the user indicates that the translation results are correct, the central processing unit serving as the unit adding document information adds “Raitaa wa kaado de kaemasuka” and “Chippu komi desuka” as the document information about the input document to the document information attached to the document-information-attached user dictionary (step A5).

If the input by the user indicates that the translation results are not correct, the user handles the mouse on the screen as shown in FIG. 14, so as to indicate whether there is a correct dictionary among the user dictionaries (step A6). If here is a correct dictionary, the correct dictionary is selected, and the document information about the input document is added to the correct dictionary (step A7). In step A6, the user may perform the selection and the document information addition with the use of the keyboard as the input device, instead of the mouse.

If there is not a correct dictionary, a new dictionary containing correct word meanings is created, and the document information about the input document is added to the created dictionary (step A8).

In Examples 1, 2, 3, 4, 5, and 6, the natural language analyzing operation is described as a machine translation operation, but may be a voice synthesis operation, a syntax analyzing operation, a morpheme analyzing operation, a text mining operation, or the like.

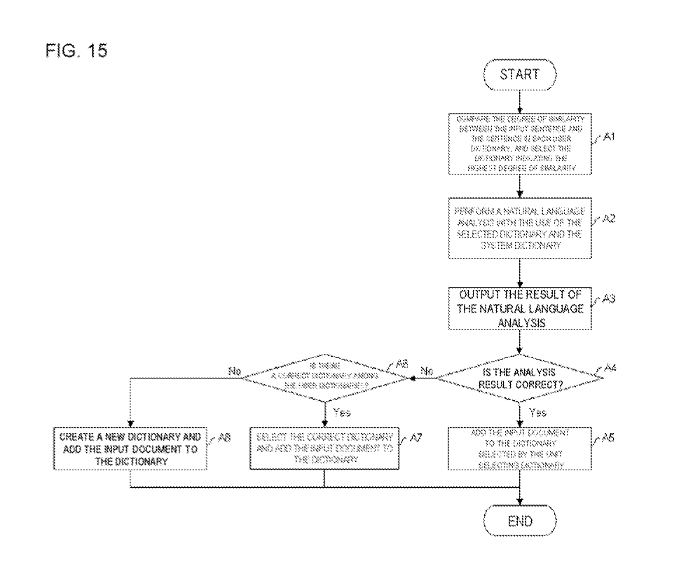

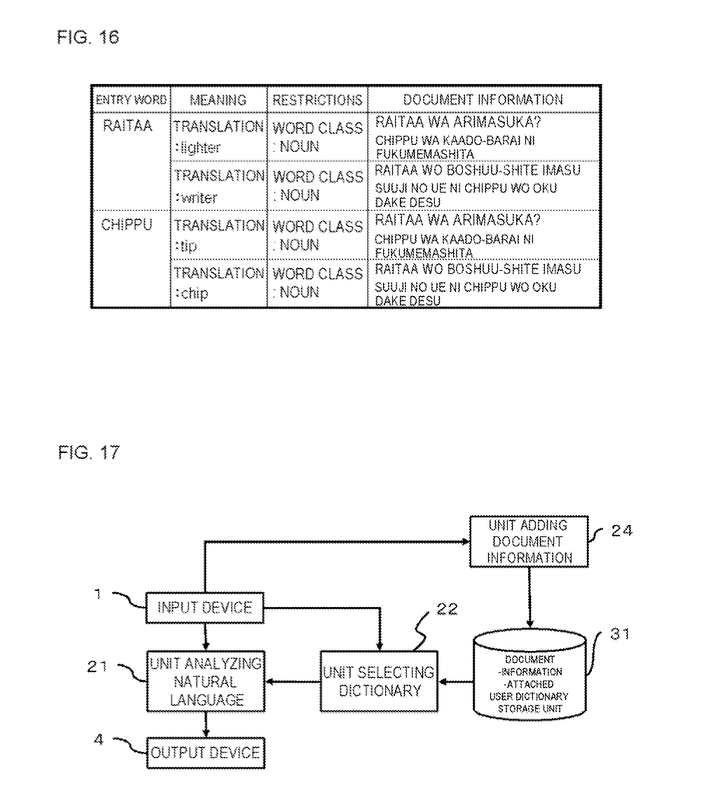

The format of each document-information-attached user dictionary may not be the format shown in FIG. 12, but may be the format shown in FIG. 16. In a format like the format shown in FIG. 16, user dictionaries are combined into one or more dictionaries. The degree of similarity between an input document and the document information about each word meaning is calculated, and an entry is selected for each word meaning. In this example case, the entry having “translation word: lighter” as the word meaning is selected for “raitaa”, and the entry having “translation word: tip” as the word meaning is selected for “chippu”.

Even if there is not a corresponding entry word contained in the document information stored in the document-information-attached user dictionaries, the unit selecting dictionary can select a dictionary in the same manner as in Example 1. Accordingly, unlike a translation system that uses conventional example sentences, this system can register the documents required for selecting word meanings in the document-information-attached user dictionaries, though the documents are not related to any of the entry words.

As the document information stored in each document-information-attached user dictionary, not only one or more sentences but also document attributes such as word use frequency information, the name or organization name of the document writer, and the URL of the document may be registered. Likewise, document attributes such as the name or organization name of the document writer and the URL of the document may be registered in each input document. In such a case, a dictionary can also be selected by calculating the degree of similarity with respect to each attribute in the same manner as in Example 1. Accordingly, an increase in the storage amount in each document-information-attached user dictionary can be prevented when many sentences are registered, and confidential documents that are not allowed to be registered as sentences can be registered in the form of attributes.

This application is based upon and claims the benefit of priority from Japanese Patent Application No. 2007-051089, filed on Mar. 1, 2007, the entire contents of which are incorporated herein by reference.

Although the present invention has been described by way of specific embodiments and examples, it is not limited to those embodiments and examples. Various changes and modifications that are obvious to those skilled in the art may be made to the structures and details described in this specification without departing from the scope of the invention.

1-31. (canceled)

32. A language processing system comprising:
an input unit that receives an input of an input document; and
a unit selecting dictionary that selects a document-information-attached user dictionary that is a user dictionary to which document information is attached,
wherein:
said document-information-attached user dictionary contains entry word information, word meanings, and document information, with the entry word information, the word meanings, and the document information being associated with one another, and
said unit selecting dictionary selects said document-information-attached user dictionary, based on a degree of similarity between said input document input from said input unit and said document information attached to said document-information-attached user dictionary.

33. The language processing system as claimed in claim 32, further comprising
a document-information-attached user dictionary storage unit that stores said document-information-attached user dictionary.

34. The language processing system as claimed in claim 32, wherein one or more sentences are attached as said document information to said document-information-attached user dictionary.

35. The language processing system as claimed in claim 32, wherein a document attribute is attached as said document information to said document-information-attached user dictionary.

36. The language processing system as claimed in claim 32, further comprising
a selected user dictionary storage unit that stores said document-information-attached user dictionary selected by said unit selecting dictionary.

37. The language processing system as claimed in claim 32, further comprising
a unit converting dictionary format that converts said document-information-attached user dictionary selected by said unit selecting dictionary into a dictionary format of another unit analyzing natural language.

38. The language processing system as claimed in claim 37, further comprising
a converted user dictionary storage unit that stores said document-information-attached user dictionary converted by said unit converting dictionary format.

39. The language processing system as claimed in claim 32, further comprising
a unit analyzing natural language that performs a natural language analysis on said input document, using said document-information-attached user dictionary selected by said unit selecting dictionary.

40. The language processing system as claimed in claim 39, further comprising:
a second input unit that receives an input from a user with respect to whether a result of the analysis performed by said natural unit analyzing natural language is correct; and
a unit adding document information that adds document information to said document-information attached user dictionary, based on contents of the input from said second input unit.

41. The language processing system as claimed in claim 39, wherein:
said input unit receives an input from a user with respect to whether a result of the analysis performed by said unit analyzing natural language is correct; and
the language processing system further comprising a unit adding document information that adds document information to said document-information attached user dictionary, based on contents of the input from said second input unit.

42. A language processing method comprising:
receiving an input of an input document, the input being received by an input unit; and
selecting a document-information-attached user dictionary that is a user dictionary to which document information is attached,
wherein:
said document-information-attached user dictionary contains entry word information, word meanings, and document information, with the entry word information, the word meanings, and the document information being associated with one another, and
said selecting the document-information-attached user dictionary includes performing said selection based on a degree of similarity between said input document input from said input unit and said document information attached to said document-information-attached user dictionary.

43. The language processing method as claimed in claim 42, further comprising
storing said document-information-attached user dictionary into a document-information-attached user dictionary storage unit.

44. The language processing method as claimed in claim 42, wherein one or more sentences are attached as said document information to said document-information-attached user dictionary.

45. The language processing method as claimed in claim 42, wherein a document attribute is attached as said document information to said document-information-attached user dictionary.

46. The language processing method as claimed in claim 42, further comprising
storing said document-information-attached user dictionary selected in said selecting the document-information-attached user dictionary, into a selected user dictionary storage unit.

47. The language processing method as claimed in claim 42, further comprising
converting said document-information-attached user dictionary selected in said selecting the document-information-attached user dictionary, into a dictionary format of another unit analyzing natural language.

48. The language processing method as claimed in claim 47, further comprising
storing said document-information-attached user dictionary converted in said converting the document-information-attached user dictionary, into a converted user dictionary storage unit.

49. The language processing method as claimed in claim 42, further comprising
performing a natural language analysis on said input document, using said document-information-attached user dictionary selected in said selecting the document-information-attached user dictionary.

50. The language processing method as claimed in claim 49, further comprising:
second receiving of receiving an input from a user with respect to whether a result of the analysis performed in said performing the natural language analysis is correct, the input being received by a second input unit; and
adding document information to said document-information attached user dictionary, based on contents of the input from said second input unit.

51. The language processing method as claimed in claim 49, further comprising:
second receiving of receiving an input from a user with respect to whether a result of the analysis performed in said performing the natural language analysis is correct, the input being received by the input unit; and
adding document information to said document-information attached user dictionary, based on contents of the input from said input unit.

52. A recording medium that stores a language processing program causing a computer to:
receive an input of an input document, the input being received by an input unit; and
select a document-information-attached user dictionary that is a user dictionary to which document information is attached,
wherein:
said document-information-attached user dictionary contains entry word information, word meanings, and document information, with the entry word information, the word meanings, and the document information being associated with one another, and
said selecting the document-information-attached user dictionary includes performing said selection based on a degree of similarity between said input document input from said input unit and said document information attached to said document-information-attached user dictionary.

53. The recording medium that stores the language processing program as claimed in claim 52, further causing the computer to
store the document-information-attached user dictionary into a document-information-attached user dictionary storage unit.

54. The recording medium that stores the language processing program as claimed in claim 52,
wherein one or more sentences are attached as said document information to said document-information-attached user dictionary.

55. The recording medium that stores the language processing program as claimed in claim 52,
wherein a document attribute is attached as said document information to said document-information-attached user dictionary.

56. The recording medium that stores the language processing program as claimed in claim 52, further causing the computer to
store said document-information-attached user dictionary selected in said selecting the document-information-attached user dictionary, into a selected user dictionary storage unit.

57. The recording medium that stores the language processing program as claimed in claim 52, further causing the computer to
convert said document-information-attached user dictionary selected in said selecting the document-information-attached user dictionary, into a dictionary format of another unit analyzing natural language.

58. The recording medium that stores the language processing program as claimed in claim 57, further causing the computer to
store said document-information-attached user dictionary converted in said converting the document-information-attached user dictionary, into a converted user dictionary storage unit.

59. The recording medium that stores the language processing program as claimed in claim 52, further causing the computer to
perform a natural language analysis on said input document, using said document-information-attached user dictionary selected in said selecting the document-information-attached user dictionary.

60. The recording medium that stores the language processing program as claimed in claim 59, further causing the computer to:
perform second receiving to receive an input from a user with respect to whether a result of the analysis performed in said performing the natural language analysis is correct, the input being received by a second input unit; and
add document information to said document-information attached user dictionary, based on contents of the input from said second input unit.

61. The recording medium that stores the language processing program as claimed in claim 59, further causing the computer to:
perform second receiving to receive an input from a user with respect to whether a result of the analysis performed in said performing the natural language analysis is correct, the input being received by said input unit; and
add document information to said document-information attached user dictionary, based on contents of the input from said input unit.
